(19) United States
(12) Patent Application Publication
(10) Pub. No.: US 2020/0090200 A1
(43) Pub. Date: Mar. 19, 2020

(54) DYNAMIC PRICING MANAGEMENT SYSTEM

(71) Applicant: Japan Display Inc., Tokyo (JP)

(72) Inventors: Taro ICHIMURA, Tokyo (JP); Kazuyoshi YOSHIDA, Tokyo (JP); Hiroshi IKEUCHI, Tokyo (JP); Norikazu HOSHI, Tokyo (JP); Keiichirou TANAKA, Tokyo (JP)

(21) Appl. No.: 16/689,801

(22) Filed: Nov. 20, 2019

Related U.S. Application Data
(63) Continuation of application No. PCT/JP2018/014801, filed on Apr. 6, 2018.

(30) Foreign Application Priority Data
May 22, 2017 (JP) 2017-101144

(51) Int. Cl. G06Q 30/02; G06Q 10/08

(52) U.S. Cl. CPC G06Q 30/0206; H04W 4/80; G06Q 10/087

(57) ABSTRACT

According to one embodiment, a dynamic pricing management system has an operation device which calculates and determines product information of each product to be displayed, plurality of electronic shelf labels each includes a display module which allows the product information to be displayed and rewritten, a communication device which allows exchange of the product information between the electronic shelf labels and the operation device, a database in which basic information of each product is stored, a management device which manages sales or inventory information of each product, and an other-than-product data collection device which collects and accumulates fluctuation data other than products with time.

### CROSS-REFERENCE TO RELATED APPLICATIONS

This application is a Continuation Application of PCT Application No. PCT/JP2018/014801, filed Apr. 6, 2018 and based upon and claiming the benefit of priority from Japanese Patent Application No. 2017-101144, filed May 22, 2017, the entire contents of all of which are incorporated herein by reference.

### FIELD

Embodiments described herein relate generally to a dynamic pricing management system.

### BACKGROUND

For example, retailers and supermarkets (hereinafter, referred to as stores) set a wide variety of commodities on display and sell them, such as fresh produce (vegetables, fish and seafood), dry food belonging to nonperishable food, kitchen accessories, clothes and articles for daily use.

They change the prices of products depending on the situation of sales and time period.

When stores change the prices of products, they consider the situation of sales in the whole store, the situation of sales of products, the situation of sales of each section, etc. They attempt to sell out products which are expired in a short time, such as freshly prepared side dishes, by reducing the prices before the closing time.

In common stores, when employees change the price of a product, they put a new reduced price label on the original label attached to the case of the target product, or replace the price label. This task is performed manually.

Depending on the product, even if the price was reduced once, an employee may attach a next new price label to the article to reduce the price again in terms of the time period, best-before date, etc.

The above changing task is normally performed by hand. Therefore, it takes a long time to finish the task. Thus, prices cannot be changed timely, and a large amount of labor is needed. When the number of products whose prices should be changed is increased, the prices of some products may not be changed.

Moreover, if the price of the same product was changed several times, a purchaser may proceed to a checkout to pay for the product before completing the change. In this case, a price difference may be raised for the same product in the cash register. Thus, unfairness (problems related to price change) may be caused.

### SUMMARY

The present application relates generally to a dynamic pricing management system.

In an embodiment, a dynamic pricing management system including an operation device which calculates and determines product information of each product to be displayed;

a plurality of electronic shelf labels each comprising a display module which allows the product information to be displayed and rewritten;

a communication device which allows exchange of the product information between the electronic shelf labels and the operation device;

a database unit in which basic information of each product is stored;

a management device which manages sales or inventory information of each product; and

an other-than-product data collection device which collects and accumulates fluctuation data other than products with time, wherein

the operation device determines current product information and issues an instruction to rewrite the product information of the display module based on the basic information, the sales or inventory information and past and current fluctuation data.

### BRIEF DESCRIPTION OF THE DRAWINGS

FIG. 1 shows a structural example of an embodiment of the present dynamic pricing management system.

FIG. 2 is an explanatory diagram showing an example of the form for classifying products in the dynamic pricing management system and the purpose of classification.

FIG. 3A shows an example of the correlation between the retail price of a product and the number of sales.

FIG. 3B further shows an example of gross profit in a graph showing the correlation between the retail price of a product and the number of sales.

FIG. 4A shows another example of the correlation between the retail price of a product and the number of sales.

FIG. 4B shows the relationship of sales and gross profit with respect to the axis representing the retail price of a product and the number of sales.

FIG. 5A shows an example of the relationship between the set retail price set in advance to produce gross profit by selling a product and the gross profit zero, and the range of fluctuation of retail price.

FIG. 5B is shown for explaining that the range of fluctuation of price differs depending on the current set retail price when the price of a product is changed.

FIG. 6 shows an operation flow when the conditions to reduce the price of each product and/or the conditions to increase the price are set to the dynamic pricing management system shown in FIG. 1.

FIG. 7A shows an example of an operation flow when the dynamic pricing management system shown in FIG. 1 operates according to the conditions of FIG. 6.

FIG. 7B is a block diagram showing a configuration example of the main modules of the dynamic pricing management system.

FIG. 7C is a block diagram showing another configuration example of the main modules of the dynamic pricing management system.

FIG. 8 shows an example of an operation flow when the dynamic pricing management system shown in FIG. 1 concurrently resets or newly sets the prices of products.

FIG. 9A shows the external appearance of an electronic shelf label and an example of its block configuration example.

FIG. 9B is an explanatory diagram showing the external appearance of a different type of electronic shelf label and its usage example.

FIG. 10A shows a display example of an electronic shelf label.

FIG. 10B shows another display example of an electronic shelf label.

FIG. 11 shows an example of an operation flow when the checkout process for the purchase of a product is performed by the dynamic pricing management system.

FIG. 12 shows an operation flow when the dynamic pricing management system makes a special decision to sell a special product.

FIG. 13 is an explanatory diagram showing an example of the setting area of electronic shelf labels controlled in a store when the sales promotion function of the dynamic pricing management system operates.

FIG. 14A is an explanatory diagram of a group of KVIs (which may be referred to as products with high awareness) and a group of non-KVIs (which may be referred to as products with low awareness) stored in a database module.

FIG. 14B shows an operation flow at the time of the category transfer process of a KVI and a non-KVI.

### DETAILED DESCRIPTION

In general, according to one embodiment, a dynamic pricing management system has an operation means which calculates and determines product information of each product to be displayed, plurality of electronic shelf labels each comprising a display module which allows the product information to be displayed and rewritten, a communication means which allows exchange of the product information between the electronic shelf labels and the operation means, a database in which basic information of each product is stored, a management means which manages sales or inventory information of each product, and an other-than-product data collection means which collects and accumulates fluctuation data other than products with time. And, the operation means determines current product information and issues an instruction to rewrite the product information of the display module based on the basic information, the sales or inventory information and past and current fluctuation data.

Embodiments will be described hereinafter with reference to the accompanying drawings. An embodiment aims at providing a dynamic pricing management system (an in-store electronic shelf label management system) which can easily change the prices of a large number of various types of products in real time and reduce the work of employees.

Another embodiment aims at providing a system which enables a customer to purchase a product with the lowest price when he/she pays for it even if the price of the product was reduced several times at intervals (price revision).

Yet another embodiment aims at providing a management system which can increase the buying motivation of customers.

Yet another embodiment aims at providing a dynamic pricing management system which can easily control the shopping route of a large number of customers in a store.

Yet another embodiment aims at providing a dynamic pricing management system which timely and appropriately balances out the sales and gross profit of KVIs and non-KVIs and optimizes, for example, the gross profit as the whole store.

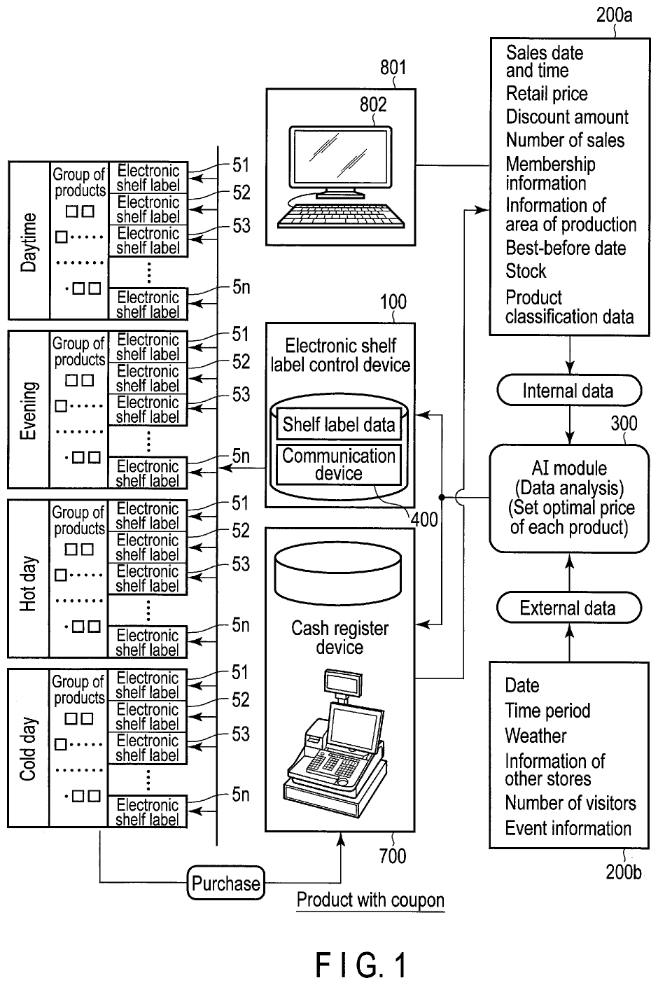

FIG. 1 shows a structural example of a dynamic pricing management system. An electronic shelf label control device 100 is connected to an artificial intelligence (AI) module 300. A database 200a and a database 200b are connected to the AI module 300. The connection mode may be direct connection or connection via a network (Internet). Databases 200a and 200b and the AI module 300 may be physically integrated with each other.

Regarding products, the sales date and time, retail price, discount amount, number of sales, membership information, information of area of production, best-before date, stock, product classification data and other types of data are stored in database 200a. Various types of information related to the surrounding environment, such as the date, time period, weather, information of other stores, number of visitors, event information and evaluation by the media and word of mouth, are stored in database 200b in series in chronological order.

The electronic shelf label control device 100 is configured to control surrounding devices based on various commands from the AI module 300, regarding the management of sales situation, products and prices.

The electronic shelf label control device 100 is configured to control, for example, a large number of electronic shelf labels 51, 52, 53, . . . 5n, provided in a store via a wireless or wired communication module (communication device 400). Specifically, for example, the on and off of the electronic shelf labels, the price information displayed on the electronic shelf labels, and flashing (eye-catching) display drawing the attention of customers are controlled. The way of calling the electronic shelf labels is not limited to this example. They may be called in various ways. For example, they may be referred to as display devices, price label devices, price display devices, electronic labels and labels.

Electronic shelf labels 51, 52, 53, . . . 5n, are provided near corresponding products, respectively, and display, for example, the prices and names of the corresponding products, respectively. In electronic shelf labels 51, 52, 53, . . . 5n, to reduce power consumption, reflective displays such as reflective liquid crystal display devices or electronic paper displays should be preferably used for the display modules described later. Further, in the electronic shelf labels, color display should be preferably realized. A barcode or a label such as an IC tag is attached to the outer package or case of each item. The barcode includes at least the ID of the product.

A customer (consumer) selects a desired item, puts it into a shopping basket or cart and moves to the place of a cash register device 700.

For example, the cash register device 700 reads the barcode attached to the item and determines price data corresponding to the barcode as a purchasing value. Normally, the barcode is read by an employee. However, in recent years, self-checkout systems have been introduced. In self-checkout systems, customers process their own purchases by themselves.

The following product classification data is further stored in database module 200a.

The set product information indicates whether each product belongs to a group of Known Value Items (KVIs) (a first product group) or a group of non-KVIs (a second product group). KVIs are products with high customer awareness in which customers remember the small changes of prices well.

Non-KVIs are products in which customers do not remember the small change of prices well. In other words, non-KVIs are products with low customer awareness in which detailed prices are difficult to remember compared with KVIs.

The prices of KVIs may determine the impression of the price standard of the whole store. Therefore, a store can create an impression of a reasonable store by making an effort to lower the prices of these products so that the customers buy more items. This strategy will also contribute to an increase in the number of repeat customers.

Various methods can be used to categorize products into KVI and non-KVI. Different stores and business fields can use their own methods. For example, a product which is frequently talked about in the subject of prices may be considered as a KVI. For example, products may be categorized by a statistical method using questionnaire investigation or extracting topics from the Internet in each store (or a specialized company). For example, questionnaire investigation may be conducted for 50 people in the exit of a store. If more than half of the people remember approximately ±15% of the actual standard price of a product, the product may be considered as the first product group. This classification includes the first product group (KVI) and the second product group (non-KVI). However, the classification may further include third and fourth product groups. The products categorized as the first product group are the products whose price changes are remembered by customers in more detail than the products of the second product group. Therefore, some products of the first product group may be transferred to the second product group or some products of the second product group may be transferred to the first product group depending on the season and store.

Some stores may use nonperishable food and fresh produce to categorize products into KVI and non-KVI as a simple method. The product information further includes, for example, the information of area of production, best-before date, cost price and range of fluctuation of price (upper limit and lower limit). KVIs may include products which are used as disposal items on a daily basis and frequently bought, such as diapers, toilet paper, tissues and detergents.

The product information includes the following information which is changed as needed: price; discount amount (or discount percentage); the number of sales (amount); the number of items in stock (amount); the total sales, situation of achievement of sales target and gross profit of each product; the total sales, situation of achievement of sales target and gross profit in each section; the total sales, situation of achievement of sales target and gross profit in the whole store; and the target of each gross profit.

The electronic shelf label control device 100 is connected to, for example, the general command module 801 of a control room. The general command module 801 may be provided in a store or remote place. When the general command module 801 is provided in a remote place, the general command module 801 is connected to the electronic shelf label control device 100 via the Internet. The general command module 801 is configured to also manage other stores. The general command module 801 comprises a monitor 802. The monitor 802 is configured to display, for example, the situation of sales of each store in real time or at a desired time. When various types of data of each store are adjusted, a program to process the above information may be adjusted using the general command module 801.

The present system is configured to automatically control an arbitrary electronic shelf label and a corresponding product price when a condition is set and/or satisfied regarding sales.

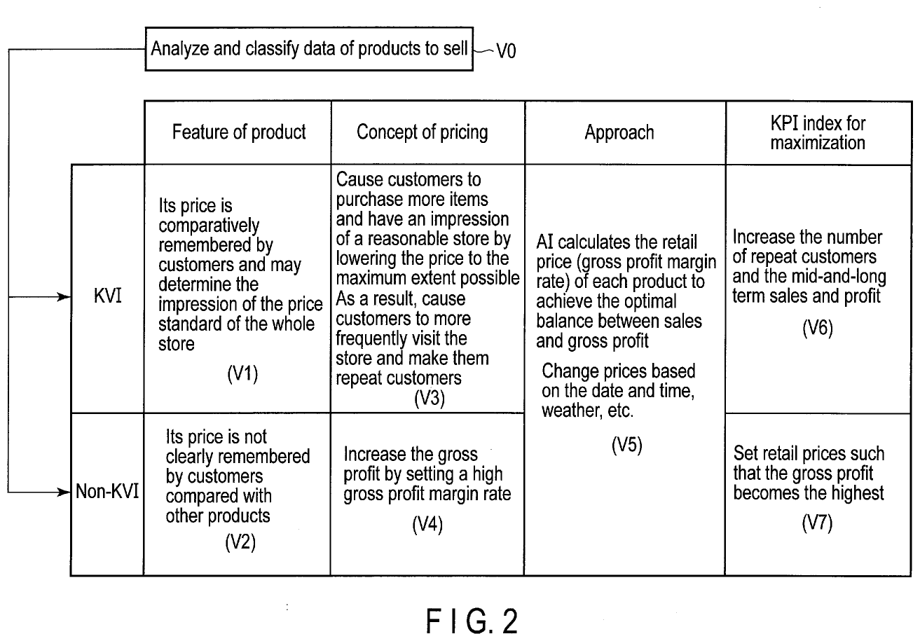

FIG. 2 shows a concept for the classification of products applied to the dynamic pricing management system. As the classification of feature of each product, each product is categorized as a KVI or a non-KVI as explained above.

In the concept of pricing on KVIs, a store places KVIs as products to create an impression of a reasonable store by lowering the prices in a possible range and increasing the number of items purchased by customers. The store uses this strategy to cause customers to frequently visit the store and make them repeat customers.

In the concept of pricing on non-KVIs, a store can place non-KVIs as products to optimize the sales and the gross profit as a whole by setting the gross profit margin rate in a relative relationship with KVIs.

In the above approach to set and change prices, the AI module 300 calculates, for example, the optimal balance between the sales and the gross profit as the whole store in consideration of the retail price (gross profit margin rate) of each product. In addition, the price of each product is changed based on the date and time, weather, etc.

As the index to achieve the target, regarding KVIs, a store aims at increasing the number of repeat customers and increasing the mid-and-long term sales and gross profit. Regarding non-KVIs, a store aims at setting the retail prices to achieve the highest gross profit.

With the above matters in mind, KVIs and non-KVIs can be sorted as follows based on the feature of each product, the concept of pricing, approach and the KPI index for maximization.

(V1) As the feature of a KVI, its price is comparatively remembered by customers and may determine the impression of the price standard of the whole store.

(V2) As the feature of a non-KVI, its price is not clearly remembered by customers compared with other products.

(V3) As the concept of pricing, a KVI is intended to cause customers to purchase more items and have an impression of a reasonable store by lowering the price to the maximum extent possible. In this way, the store aims at causing customers to more frequently visit the store and making them repeat customers.

(V4) As the concept of pricing, a non-KVI is intended to increase the gross profit by setting a high gross profit margin rate.

(V5) As the approach, for both KVIs and non-KVIs, AI calculates the retail price (gross profit margin rate) of each product to achieve the optimal gross profit. In addition, the prices are changed based on the date and time, weather, etc.

(V6) As the KPI index for KVIs, a store aims at increasing the number of repeat customers and the mid-and-long term sales and profit.

(V7) As the KPI index for non-KVIs, a store aims at setting retail prices such that the gross profit becomes the highest.

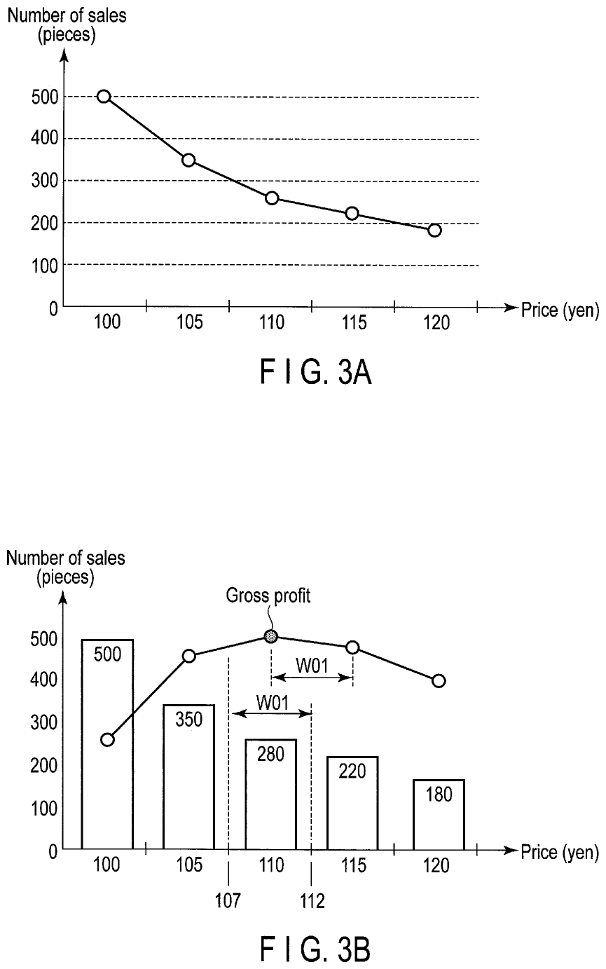

FIG. 3A shows that the price of a product (horizontal axis ranging from 100 yen to 120 yen) correlates with the number of sales (vertical axis ranging from 100 to 500). As the price is increased, the number of sales is decreased. FIG. 3B shows the result of analysis of the price and the number of sales to obtain the maximum gross profit. In this example, the highest gross profit is achieved when the price is 110 yen and the number of sales is 280. The second highest gross profit is obtained when the price is 115 yen and the number of sales is 220.

The characteristic curve of the gross profit of FIG. 3B shows that the gross profit is increased when, for example, the set retail price of 115 yen is decreased to the 110-yen side. At this time, there is a possibility that the highest gross profit is achieved if the price is changed from 115 yen to 110 yen (a discount of 5 yen, in other words, a discount of range W01). However, the curve also shows that the gross profit is decreased when the set retail price of 112 yen is decreased to 107 yen (a discount of 5 yen, in other words, a discount of range W01). Although the gross profit is increased with a reduction to a certain price (110 yen), the gross profit is decreased if the price is further reduced.

Therefore, a discount of the same range W01 is not always effective for the set retail price of the same product. A method of setting, for example, 112 yen as the standard set retail price and setting 110 yen as the lower limit and 115 yen as the upper limit (in other words, setting W01 as the range of fluctuation) can be adopted depending on the sales strategy of the store.

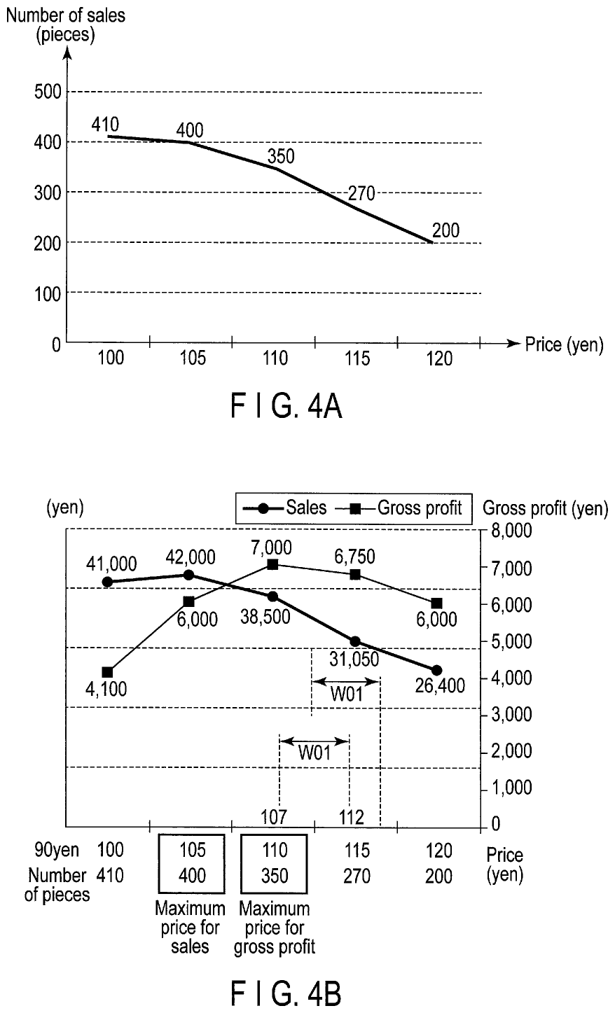

FIG. 4A shows the correlation between the number of sales and the price of another product. FIG. 4B shows an example in which the highest sales are obtained by selling the product when the number of pieces is 400 and the price is 105 yen, and an example in which the highest gross profit is achieved by selling the product when the number of pieces is 350 and the price is 110 yen. In this case, the store sets the price depending on whether they desire the highest sales or the highest gross profit.

As described above, it is possible to maximize the gross profit or maximize the total sales in terms of data. However, in an actual situation, because of the weather, buying situation, inventory status, traffic situation or good or poor harvest, a store may have to sell a product even if the gross profit is low. Further, a store may want to increase the gross profit, or want to achieve an intermediate gross profit between the maximum and minimum, or have to sell a large number of pieces even if the gross profit is the lowest.

The explanation of FIG. 3B is also applied to the case of FIG. 4B. The characteristic curve of the gross profit shows that the gross profit is increased when, for example, the set retail price of 115 yen is decreased to the 110-yen side (a discount of range W01). However, the curve also shows that the gross profit is decreased when the set retail price of 112 yen is decreased to 107 yen (a discount of 5 yen, in other words, a discount of range W01). Although the gross profit is increased with a reduction to a certain price (110 yen), a rate of the gross profit is decreased if the price is further reduced. Therefore, it should be noted that a discount of the same range W01 is not always effective for the set retail price of the same product.

A method of setting, for example, 112 yen as the standard set retail price, and setting 110 yen as the lower limit and 115 yen as the upper limit (in other words, setting W01 as the range of fluctuation) can be also adopted.

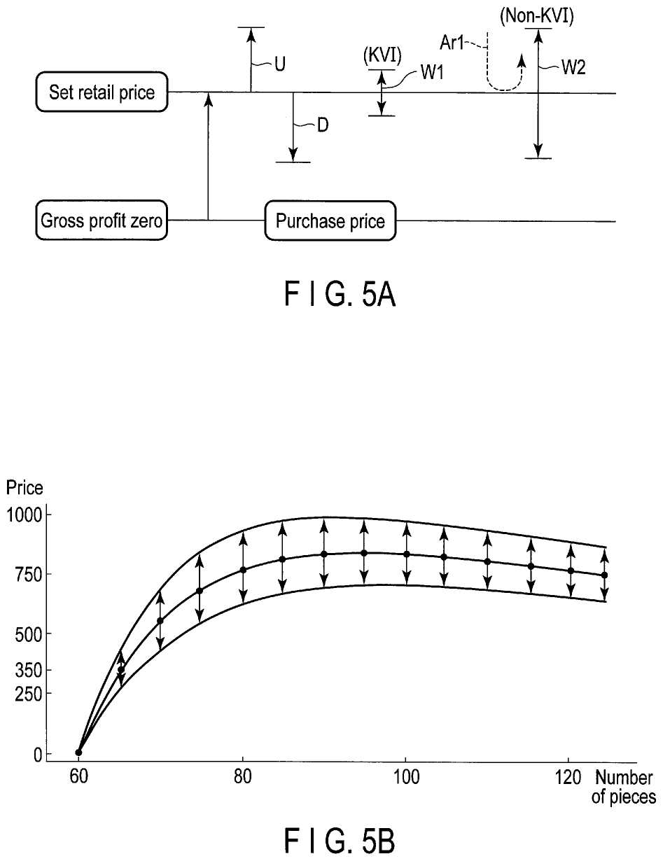

FIG. 5A shows the relationship between the set retail price set in advance as the standard to produce the above gross profit and the gross profit zero (purchase price). Stores normally determine a set retail price to produce gross profit, in other words, an inflated price.

Stores basically set a price higher than the set retail price when they want to increase the gross profit (U). When the gross profit should be decreased, they set a price lower than the set retail price (D). In FIG. 5A, W1 represents the range of fluctuation of retail price of a KVI, and W2 represents the range of fluctuation of retail price of a non-KVI. When the retail price is changed, for example, the following program can be adopted. The upper limit may be set as the retail price in the morning, and the price may be reduced to the set retail price or a price lower than the set retail price toward evening. Depending on the product and its sales method, as shown by arrow Ar1, for example, the upper limit may be set as the retail price in the morning, and the price may be reduced to the set retail price toward the noon, and increased in the direction of the upper limit toward evening. For example, the price of a limited number of pieces (in stock) may be increased.

The reasons for W1<W2 are as follows. As explained above, customers are strict with the fluctuation of prices of KVIs and are not very strict with the fluctuation of prices of non-KVIs.

It should be noted that, as explained in FIG. 3B and FIG. 4B, in some zones, the gross profit can be increased even if the retail price is made low. However, in some cases, a store may not be able to necessarily set an advantageous price because of the effect of rival stores.

In any case, as the concept of the present management system, the range of fluctuation W1 for a KVI and the range of fluctuation W2 for a non-KVI are set so as to satisfy the relationship of W1<W2.

In the above description, the range of fluctuation is explained. However, when product information is determined, a method of setting the frequency of price changes of the first product group (KVI) so as to be less than that of the second product group (non-KVI) may be used.

When the highest price (upper limit) and the lowest price (lower limit) for the set retail price are determined as described above, the range of fluctuation of the retail price of the product is determined. The same range of fluctuation is not necessarily set for all retail prices. As explained in FIG. 3B and FIG. 4B, the upper limits of the number of sales and the gross profit differ depending on the set price.

In the present management system, as shown in FIG. 5B, the range of fluctuation of price is calculated by the AI module 300 in advance for each product and is stored in database module 200a based on the set retail price of the product. In the example of FIG. 5B, the plotted positions of the characteristic curve are the set retail prices. The vertical (longitudinal) arrow of each plotted position is the range of fluctuation of price (which may be also referred to as an allowable range of fluctuation of price). The figure reveals that, if the range of fluctuation of price is set so as to be wide when the set retail price is cheap (for example, 350 yen) in a manner similar to that of a case where the set retail price is expensive (for example, 730 yen), the gross profit is significantly decreased. In the present management system, when the set retail prices of products differ from each other, different ranges of fluctuation are set.

The characteristic curve and the range of fluctuation of price described above can be obtained by calculating and analyzing various types of data from the databases with a plurality of algorithms. The algorithms to be used are, for example, an algorithm executing a generalized linear model, an algorithm executing a hierarchical Bayesian model and an algorithm executing a multilayered neural network (deep learning).

The generalized linear model is a model which presumes a linear relationship with respect to, for example, the relationship between the score of the gross profit and the product price or other variables. The hierarchical Bayesian model is a model which estimates the posterior distribution of the target prediction value by preparing, for example, a large number of linear models showing the relationship between the score of the gross profit and the explanatory variables of the number of products and price. The multilayered neural network is a model which does not presume any model between, for example, the score of the gross profit and an explanatory variable and learns the relationship between them.

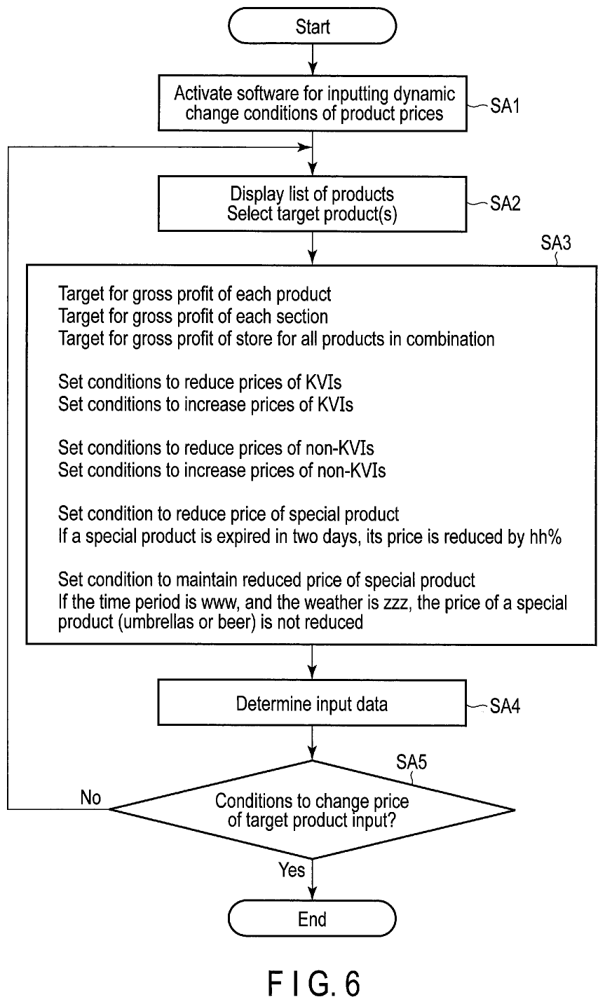

FIG. 6 shows an operation flow to set conditions necessary to control the price of each product depending on the sales situation of the product in the above dynamic pricing management system. For example, the general command module 801 and its monitor 802 are used for the screen for constructing the operation flow.

For example, the operation keyboard of the general command module 801 is operated, and software for inputting the dynamic change conditions of product prices is activated (SA1). When the general command module 801 manages a plurality of stores, the user can specify the store to be controlled by inputting the identification data of the store.

When the software for inputting dynamic change conditions is activated, a list of products of the store is displayed. When the user inputs a classification item of the list of products from an operation module, a short list of products is displayed. From the list, the user selects the product(s) whose conditions should be set (SA2). A single or more products may be selected. A list of KVIs and a list of non-KVIs may be separately displayed according to the classification made in advance.

When the user sets the conditions to change a price, the user specifies a product, and inputs the name of the product and figures to the blanks displayed on the monitor (SA3). For example, the present system allows the settings for changing the price of a non-KVI in a range of ±10% with respect to the set retail price by fully utilizing the data of database modules 200a and 200b and the function of the AI module. The sales and the gross profit as a whole can balance each other out by, for example, appropriately and timely changing the prices of non-KVIs depending on information which sequentially changes, such as the date and time, weather and season, while maintaining a narrow range of ±3% of the set retail price for products (KVIs) whose prices easily affect the perception of consumers. As an additional function, the gross profit obtained by non-KVIs can be appropriately used to further reduce the prices of KVIs. The store may use this method to exhibit their feature and edge.

For example, when the user selects a product on the monitor, the conditions to increase the price and the conditions to reduce the price are displayed on the monitor. In addition, the increased price and the reduced price are displayed with selection buttons compared with the set price. The user may select the desired selection button by clicking it with a cursor or touch operation.

For example, a condition to permit an increase in price and a condition to permit a reduction in price with respect to the set retail price are able to set as follows on the monitor.

“If the gross profit of the whole store is currently+bb,bbb yen for the target figure, the price of the product is reduced from ccc yen to ddd yen”.

Alternatively, “if the gross profit of the whole store is currently −bb,bbbb yen with respect to the target figure, the price of the product is increased from ccc yen to eee yen”.

From above description, it is said that the management system can display a recommendation price of a price variation value of the product on the monitor, by inputting in advance the expected sales number and/or the expected gross profit with the products.

As a matter of course, in addition to the gross profit, for example, the information of the number of sales or sales performance, the performance until one day ago or two days ago and the performance of each week may be considered to modify the range of reduction and the range of fluctuation.

The price of a product having a special condition may be changed even if the gross profit is low. For example, as a condition to reduce the price of a special product, the user can input the condition “if the gross profit of section fff is greater than or equal to gg %, and special product BN will be expired in two days, the price of special product BN is reduced by hh %” in accordance with an input guide screen.

Moreover, depending on the environment condition, a condition to maintain the reduced price of a special product can be set. For example, the condition is “if the time period is www, and the weather is zzz, the price of a special product (umbrellas or beer) is not reduced”. The above methods for setting conditions are merely examples. Other methods and conditions may be adopted. Since the present management system uses the AI module 300, the management system presents, on the screen of the monitor 802, information useful to set various prices. The information includes the balance of supply and demand associated with production and manufacturing, and the change of demand which is difficult to predict by the media and word of mouth. For example, the information “the shipping volume of cabbage is decreased because of the disaster in production area GG of cabbage” is presented. Thus, the present management system can present information which is likely to have an influence on the fluctuation of prices of products to the user.

After the above various conditions are set, input data determination operation is conducted (SA4). Whether or not all the conditions to change the price of the target product are input is determined (SA5). When the input is completed, the process is terminated.

Since each store or company has their own sales strategy, they do not need to use the same conditions as the above conditions. For example, program software for causing an AI function standardized to an extent to operate may be provided from a specialized company to stores. In each store, the person in charge may adjust or modify the parameters to finely adjust part of the sales strategy.

As the name of each product differs depending on the area and country, the user of the area of the store may modify the name. A foreign language may be added to the first language on the surface of the product depending on the residents.

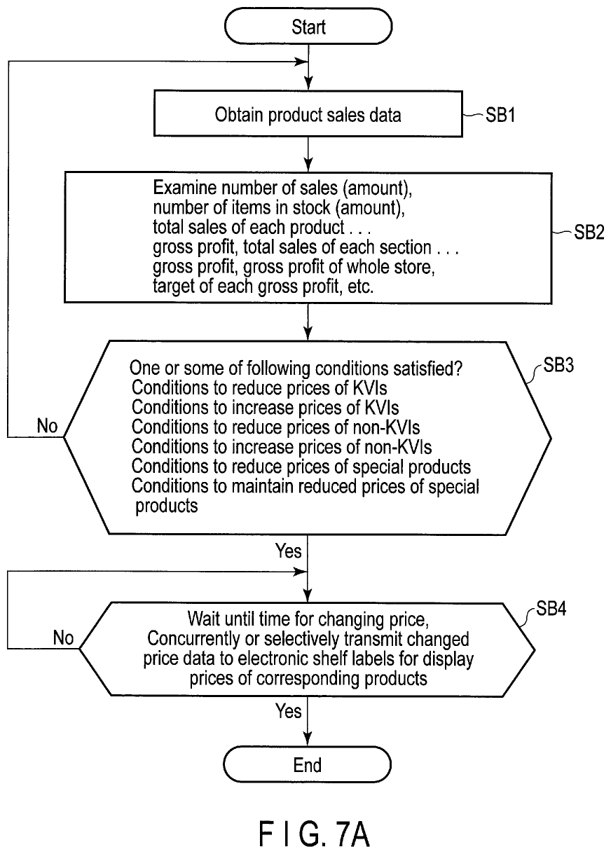

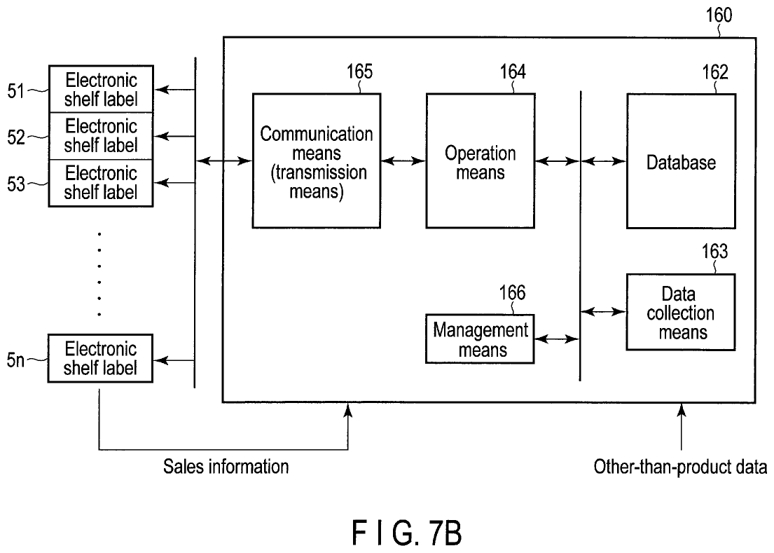

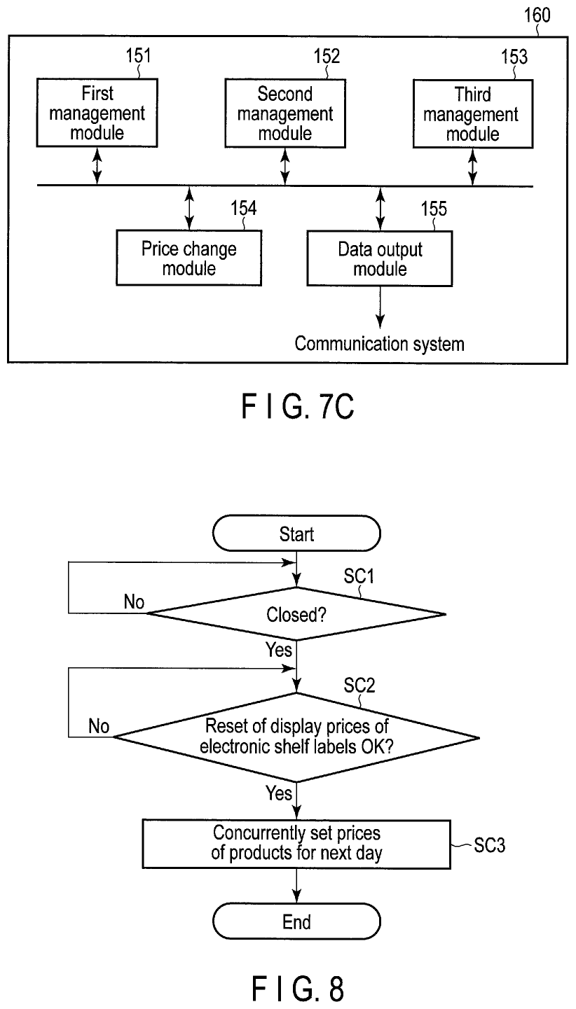

FIG. 7A is an operation flow when the electronic shelf label control device 100 changes the prices of products based on the above various conditions. Product sales information is transmitted from the cash register device 700. Product sales data is obtained (SB1). The number of sales (amount), the number of items in stock (amount), the total sales and gross profit of each product, the total sales and gross profit of each section, the gross profit of the whole store and the target of each gross profit are examined using sales data (SB2).

Whether or not one or some of the conditions explained in FIG. 6 are satisfied is determined (SB3). When the conditions to change a price are satisfied, the electronic shelf label control device 100 waits for a changing process until the time set in advance depending on the product. The changed price data of each product is automatically transmitted to a corresponding electronic shelf label through the communication device 400 at a corresponding changing time (SB4).

Since the changing operation is not performed manually by employees, the prices of a large number of products can be very easily and concurrently changed at once. The present management system allows the change of the prices of products in real time.

The following process is performed by the structure shown in FIG. 7B. The portion structured by the electronic shelf label control device 100, database modules (may be called database unit or database device) 200a and 200b, the AI module 300, etc., shown in FIG. 1 and its function can be collectively shown as a complex control module (may be called a complex control device or a complex controller) 160. The complex control module 160 comprises a database 162, a data collection module (may be called a data collection device or a data collector) 163, an operation means (may be called operation device, or operator) 164, a communication means (may be called a transmission device, a communication device, or a communicator) 165 and a management means (may be called management device or a manager) 166.

The operation means 164 calculates and determines the product information of products on display in a store. The product information includes at least the price of each product, and may include the name of each product. The basic information of each product is stored in database 162. For example, the basic information includes the cost price, set retail price and information of area of production of each product. The management means 166 manages, for example, the sales or inventory information of each product.

The data collection means 163 is configured to collect and accumulate fluctuation data other than products with time. The fluctuation data includes at least the weather information of the place of the store, and may include, for example, the temperature, time periods, neighborhood event information and event time periods. The communication means 165 enables the exchange of the product information between a plurality of electronic shelf labels 51 to 5n and the operation means 164. Each of electronic shelf labels 51 to 5n comprises a display module which allows the product information to be displayed and rewritten.

In the complex control module 160, the operation means 164 is configured to determine the current product information and issue an instruction to rewrite the product information of each display module based on the basic information, the sales or inventory information and the past and current fluctuation data. More specifically, the operation means determines the optimal pricing fluctuation of a day for a product or all the products (the pricing fluctuation of the product(s) with time) as a predicted value based on the basic information and past fluctuation data (the price may not be changed in a day or a predetermined period). Before ultimately changing the display of the price of the electronic shelf label of each product based on the predicted value, the operation means reconsiders the price, taking the current fluctuation data into consideration in addition to the predicted value. The current fluctuation data includes, for example, the weather, temperature and humidity of the place of the store at the time, and the event information and traffic information around the store. The current fluctuation data further includes the number of customers in the store at the time. This data may be also called current other-than-product information. The past fluctuation data includes the fluctuation of price and sales situation (volume of inventories) of the product and the fluctuation of price and sales situation of other products associated with the past other-than-product information. This data is stored in the database with time. Of the other-than-product information, the weather and traffic information of the place of the store can be obtained through the Internet. The sales situation of the product and the sales situation of other products associated with the other-than-product information can be obtained from the cash register device. This data is stored in the database with time. For example, when the price of an umbrella is changed, basic information includes the size, color and price of the umbrella. The past fluctuation data indicates the sales situation and the fluctuation of price of the umbrella until the price of the umbrella is changed this time, and further, the fluctuation of price and sales situation of other products such as other umbrellas, raincoats, towels and tissues. The ultimate price of the umbrella is calculated by the operation means in consideration of the above data. This price can be changed as needed depending on the situation of fluctuation of the current fluctuation data. For example, when the sales of raincoats are rapidly increased, there is a possibility that a further reduction in the price of the umbrella is considered. At the same time, there is a possibility that a reduction in the price of tissues is considered. If rain stops suddenly, there is a possibility that the maintenance of the price of the umbrella is considered. As described above, the operation means determines prices in consideration of the current fluctuation data in addition to the past fluctuation data. The determined prices are immediately reflected on the electronic shelf labels in the store. In this way, the prices of all the products of the store can be determined based on the situation, thereby effectively operating the whole store. By using the above means, even if the number of electronic shelf labels is large, or the prices of a large number of products are changed, the display of the names and prices of products of the electronic shelf labels can be accurately changed at the same time or in a successive manner.

When the operation means 164 determines product information, the operation means 164 is configured to categorize the products displayed in the store into products with high awareness and products with low awareness based on the basic information, sales performance information and fluctuation data, take in the parameters of the categories and determine product information (prices).

The operation means 164 sets the range of fluctuation for the standard price of products with high awareness so as to be less than the range of fluctuation for the standard price of products with low awareness. The fluctuation data used for change at this time is one of the weather information, time, event information and temperature of the place of the store or a combination thereof.

The complex control module 160 comprises the following functions. The complex control module 160 comprises a plurality of electronic shelf labels 51 to 5n, database 162, the other-than-product data collection means 163, the operation means 164 and the transmission means 165.

Electronic shelf labels 51 to 5n are attached to a plurality of types of products on display, respectively, and comprise display modules which display their respective product information. The basic information of each product is stored in database 162. The other-than-product data collection means 163 collects and accumulates fluctuation data other than products with time. The operation means 164 calculates and determines product information based on the basic information and the fluctuation data. The transmission means 165 transmits the product information determined by the operation means 164 to electronic shelf labels 51 to 5n.

The basic information includes at least category information indicating whether each product is categorized into the first product group or the second product group with price awareness lower than the first product group. When the operation means 164 determines the product information, the operation means 164 sets the frequency of price changes (or the range of fluctuation) of the first product group so as to be less than the frequency of price changes (or the range of fluctuation) of the second product group.

FIG. 7C shows a structure by another aspect of the complex control module 160. The complex control module 160 of the electronic shelf label control device 100, database modules 200a and 200b and the AI module 300 shown in FIG. 1 includes a first management module 151, a second management module 152 and a third management module 153. The complex control module 160 further includes a price change module 154 and a data output module 155. This structure may be singly provided in the electronic shelf label control device 100. In this case, the electronic shelf label control device 100 loads necessary data and information from database module 200 and the AI module 300 and uses the data and information. The AI module 300 may provide software for performing the processes shown in FIG. 2 and FIG. 3A. Database module 200 provides the external data (the information of current situation) and internal data (product information) shown in FIG. 1, etc.

The first management module 151 mainly pursues the sales situation of the first product group including KVIs, and manages the status of the achievement of a first sales target. The second management module 152 mainly pursues the sales situation of the second product group including non-KVIs (for example, including fresh produce), and manages the status of the achievement of a second sales target. The third management module 153 manages the status of the achievement of a third sales target obtained by combining the first sales target and the second sales target for the whole store and/or each section. The price change module appropriately changes the price of each product in consideration of the sales target of each management module.

The data output module 155 outputs the change data of the price change module 154 to a communication system which transmits the data to an electronic shelf label provided near the product whose price should be changed.

The price change module 154 may reconsider and reset the prices of all the products or some products of the store depending on the conditions of external data. Even in this case, the increase rate (W1 of FIG. 5A) of the products included in the first product group is set so as to be less than the increase rate (W2 of FIG. 5A) of the products included in the second product group.

In the above structure, the third management module 153 is configured to function as a reset module which resets the price of each electronic shelf label as explained below.

The products of the second product group include, for example, a cake and fried chicken for a Christmas Eve party. These products may be specified as special products whose prices are specially reduced after Christmas Eve as explained later.

FIG. 8 is a flowchart showing the operation performed when a store newly sets the prices of products for the next day after store hours. The closing of the store is input to the dynamic pricing management system through the general command module 801 (SC1). Subsequently, when the operation button to allow the display prices of electronic shelf labels to be reset is pressed (SC2), the display prices of the electronic shelf labels of the products in which the information of prices is renewed are concurrently set (SC3). The prices of a large number of products can be easily set. Employees do not need to manually replace the price label of each product.

Further, the present dynamic pricing management system is configured to manage the number of items in stock. It is possible to obtain ordering data for the next order from the data of the number of sales A and stock B. The ordering data may be adjusted based on the season, change in temperature and weather forecast. For example, when a typhoon is likely to come, there is a possibility that the store cannot receive further products on the day of typhoon. Therefore, the store can make an adjustment so as to increase the number of items in stock on the previous day. The information of current situation received from outside may include the information of the number of cars in a parking area.

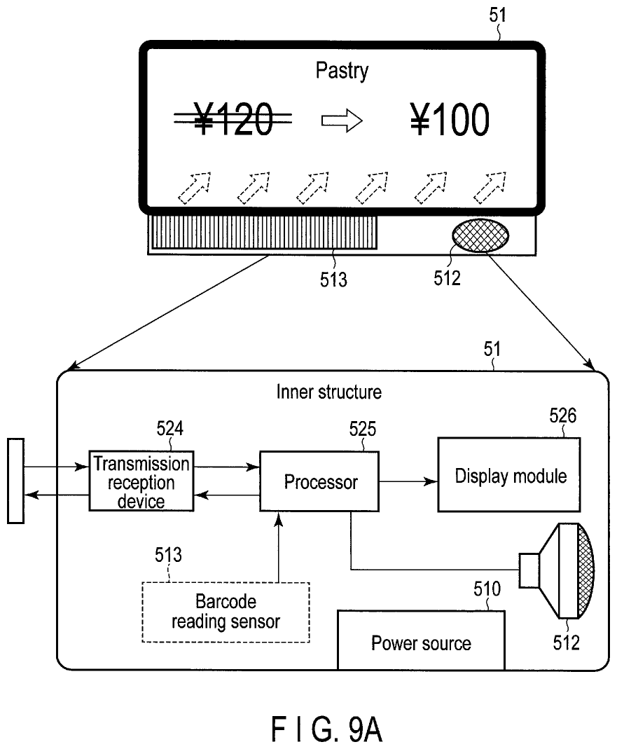

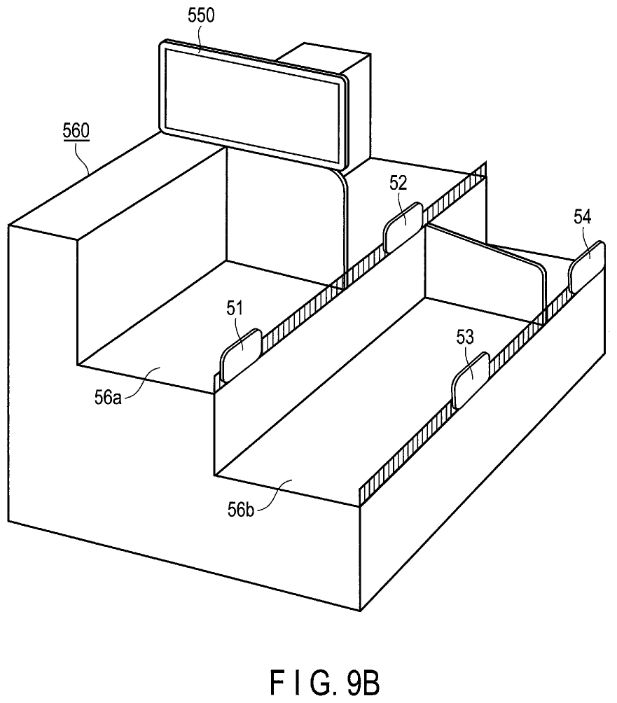

FIG. 9A simply shows the external appearance of electronic shelf label 51 and the inner functional blocks. Electronic shelf label 51 is configured to communicate with the communication module 400 via an antenna. Various systems can be adopted as a communication system. For example, short-range wireless communication, WiFi (registered trademark) communication, Bluetooth (registered trademark) communication and other communication systems may be used.

Electronic shelf label 51 includes at least a transmission reception device 524, a processor 525 and a display module 526. Electronic shelf label 51 may further include a speaker 512 and a microphone (not shown). A barcode reading sensor 513 may be further provided. As a power source 510, a battery may be used. Alternatively, power may be supplied from outside through a power supply line.

In the example of FIG. 9A, the display module 526 indicates that the price of a product (pastry) is decreased from 120 yen to 100 yen. In this way, the present dynamic pricing management system uses an electronic shelf label at an appropriate time. Therefore, the price of each product can be quickly changed any number of times.

Further, as electronic shelf label 51 comprises the speaker 512 and the microphone, for example, when a special operation button is pressed, a customer can speak with the manager room of the store. Through the microphone, the conversation information of customers can be collected as reference data. When electronic shelf label 51 comprises a camera, various types of monitoring data can be obtained in a small area. As a matter of course, an exclusive monitoring camera which monitors the whole store may be provided.

FIG. 9B shows the external appearance of a different type of electronic shelf label and its usage example. In the example, electronic shelf labels 51, 52, 53 and 54 of the present dynamic pricing management system are provided in stages 56a and 56b of a display shelf 560. The present system comprises a large shelf label 550 whose area is large in addition to small electronic shelf labels 51, 52, 53 and 54. Small electronic shelf labels 51, 52, 53 and 54 are provided near the respective products such that they can be easily seen when customers face the display shelf 560. However, the large shelf label 550 is provided in a direction different from that of small electronic shelf labels 51, 52, 53 and 54, and is provided at the top of the display shelf 560. The reasons for this layout are as follows. The large shelf label 550 displays a list of neighboring products and the name of classification of neighboring products. Thus, the large shelf label 550 is provided such that it can be recognized from a distance or by people waking so as to face the aisle direction between display shelves. When a product with a reduced price is located near the large shelf label 550, the large shelf label 550 can be used for the eye-catching advertisement of the product, such as flashing.

Therefore, the price change module 154 which outputs data for electronic shelf labels is configured to supply data to both the small electronic shelf labels and the large shelf label. Moreover, the price change module 154 is configured to output data related to a list of products near the large shelf label to the large shelf label.

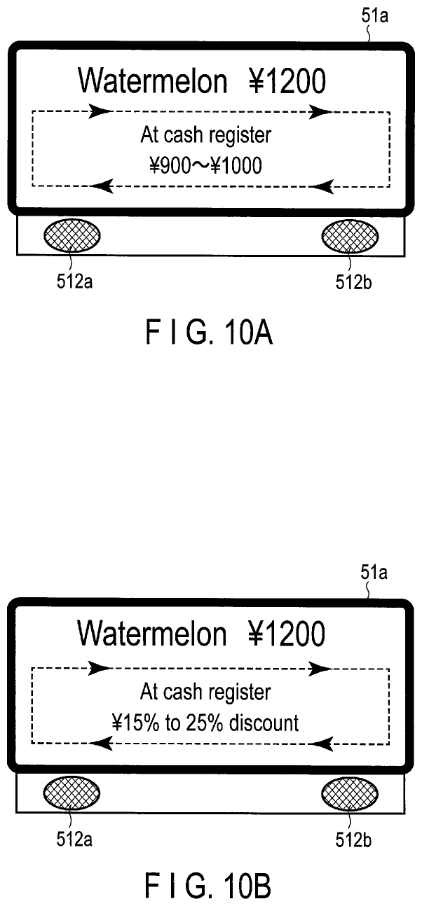

FIG. 10A and FIG. 10B show other display examples of an electronic shelf label 51a. The display example of FIG. 10A indicates that, for example, the product (watermelon) of 1200 yen is purchased in a range of 900 yen to 1000 yen when a customer pays for it at the cash register device. AI or the electronic shelf label control device 100 determines which price from 900 yen to 1000 yen is applied depending on the sales situation of the whole store or the product. For example, this information is announced by speakers 512a and 512b.

If a customer picks the product up and immediately pays for it at the cash register device, the price may be 1000 yen. If a customer picks the product up, and pays for it at the cash register after a while, the price may be 900 yen. However, the price is determined based on the sales situation of the whole store or the product. Therefore, even if the number of visitors is less, the price of the product is not necessarily significantly reduced.

In the display method of FIG. 10A, a price selected from a range of 1000 yen to 900 yen is applied to the product of 1200 yen when a customer pays for it at the cash register. However, as shown in FIG. 10B, the electronic shelf label may indicate that a 15% to 25% discount is applied to the product of 1200 yen when a customer pays for it at the cash register device.

As described above, in the present management system, when the barcode of a product whose price should be changed is read by the cash register device, the cash register device applies the current lowest price applied by the price change module to the price of the product. Therefore, if the price applied when a customer puts the product into a shopping basket is higher than the price applied when the customer pays for it at the cash register, the current lower price is applied at the cash register. In this way, the dissatisfaction of customers raised from the difference in price between when the product is put into the shopping basket and when the product is actually purchased at the cash register is eliminated.

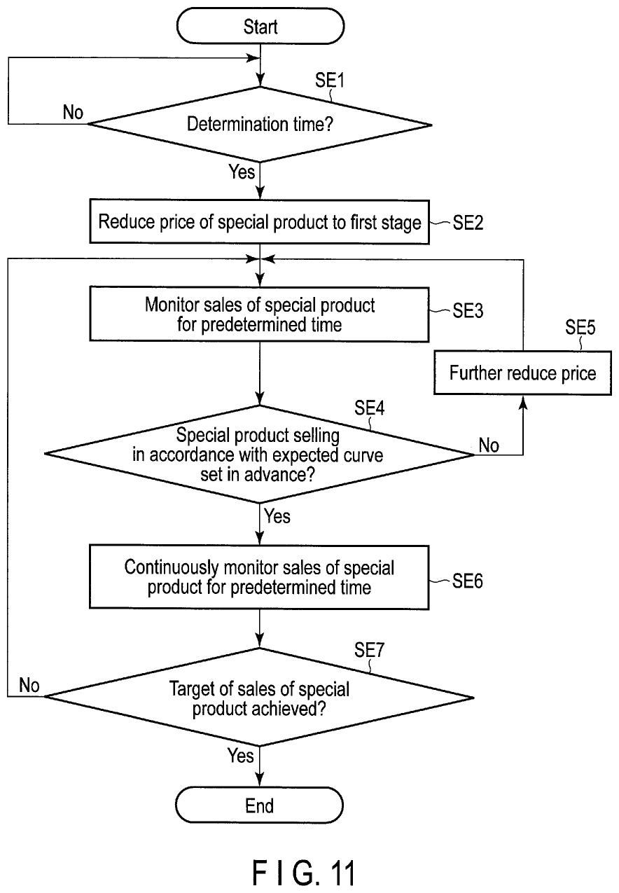

FIG. 11 shows an operation flow when a special sales process is performed regarding the sales of a special product. A special product is, for example, a Christmas cake on the next day of Christmas Eve, or a product whose best-before date is today or the next day (freshly prepared side dish, sashimi, sushi, tempura, etc.). Regarding these special products, it may be more advantageous as a store by reducing the prices and selling them out while ignoring the profit, regardless of whether they are non-KVIs or KVIs. At the time for determining whether or not the price of a special product should be reduced (SE1), the price is reduced to a first stage through an electronic shelf label (SE2).

The determination may be automatically conducted, or manually ordered from the general command module 801 of the control room. After the price of the special product is reduced to the first stage, the sales of the special product are monitored for a predetermined time (SE3). While monitoring the sales, whether or not the special product is selling in accordance with an expected curve is determined (SE4). When it is determined that the special product is not selling well, the price is further reduced (SE5). When it is determined that the special product is selling well, the sales of the special product are continuously monitored for a predetermined time (SE6). While monitoring the sales, whether or not the target of the sales of the special product is achieved is determined (SE7). When it is determined that the target of the sales of the special product is achieved, the process is terminated. When it is determined that the target is not achieved, the process returns to step SE3.

The above sales operation process can minimize the unsold special products in the store and contribute to the sales of the store and the control of gain and loss. The present dynamic pricing management system controls the display of electronic shelf labels, thereby easily performing the above sales operation process.

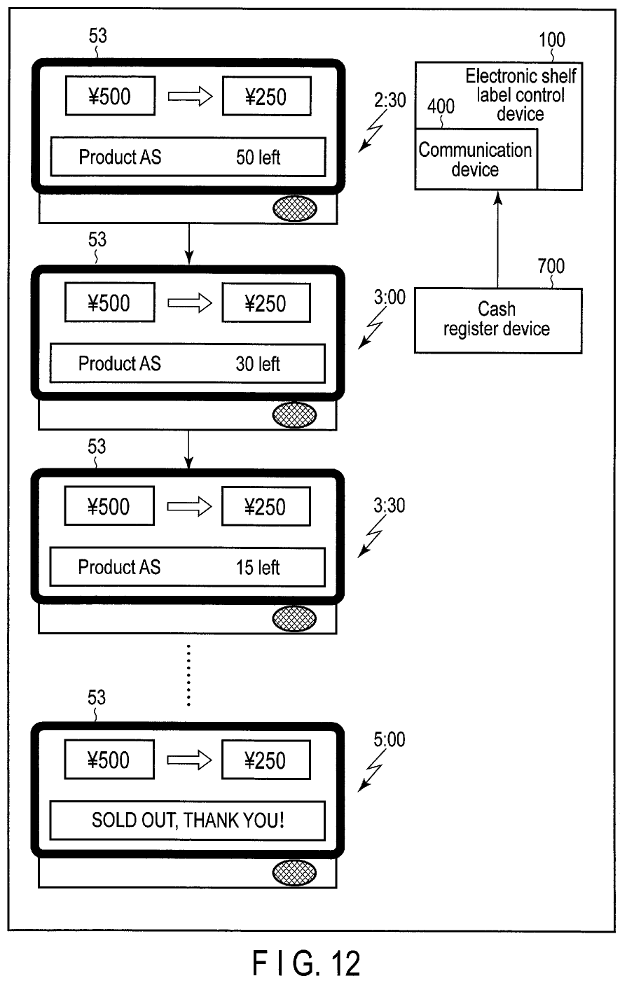

FIG. 12 is shown for explaining a function which can be realized by the present dynamic pricing management system and is effective in sales promotion. The present dynamic pricing management system is configured to immediately switch the display prices by controlling electronic shelf labels. For example, it is assumed that electronic shelf label 53 indicates that a product is reduced from 500 yen to 250 yen. At the same time, the number of pieces to which this price is applied is displayed. For example, electronic shelf label 53 indicates that product AS is reduced from 500 yen to 250 yen, and the number of remaining pieces is 50.

After a while, as a customer purchases product AS, the information is transmitted from the cash register device to the electronic shelf label control device 100. The electronic shelf label control device 100 manages the sales of product AS and counts the number of remaining pieces. The information is transmitted to electronic shelf label 53 through the communication system 400. Accordingly, electronic shelf label 53 updates the number of remaining pieces of product AS. The example of FIG. 12 shows that the number of remaining pieces is firstly decreased to 30, and secondly decreased to 15 in series, and is lastly indicated as “SOLD OUT, THANK YOU”.

As described above, the present dynamic pricing management system can immediately change the price of each electronic shelf label, thereby notifying shoppers of the change in the number of remaining pieces of reduced products with time. The present dynamic pricing management system can further improve the effect of sales promotion. As described above, the price change module 154 is configured to output, as change data, data regarding the number of remaining pieces to sell as well as the changed price of each product to the data output module. The system can concurrently control the display state of a large number of display devices. In the above explanation, the number of remaining pieces is displayed. However, the weight of each product to sell, or the number of customers who can purchase each product may be displayed.

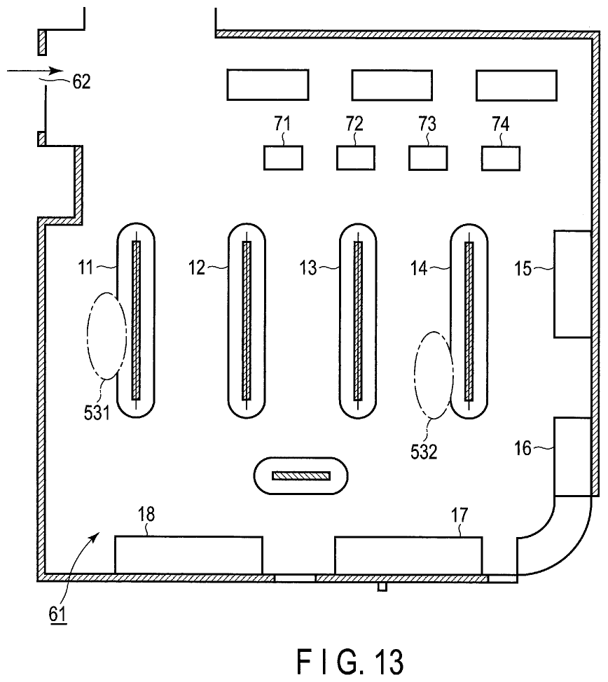

FIG. 13 shows a layout example of merchandise display shelves on a floor 61 in a store. The floor 61 is, for example, substantially rectangular, and comprises an entrance 62. When the floor 61 is seen from the entrance 62, work tables 71a, 71b and 71c are provided at intervals in the front direction (in other words, the right-left [lateral] direction of the figure). Cash register devices 71, 72 and 73 are provided at intervals under work tables 71a, 71b and 71c across an intervening space in the vertical (longitudinal) direction of the figure. Merchandise display shelves 11, 12, 13 and 14 which are slender in the longitudinal direction are provided with aisles in the lateral direction in the center of the floor 61. Merchandise display shelves 15, 16, 17 and 18 are further provided along the walls.

Although not shown in the figure, electronic shelf labels indicating the prices of products, respectively, are provided near the products of the merchandise display shelves.

When the discount event explained in FIG. 10A, FIG. 10B or FIG. 12 is conducted, there is a possibility that customers crowd around the corresponding electronic shelf label (target product). When the sales promotion function of the present dynamic pricing management system is operated, setting areas 531 and 532 of electronic shelf labels controlled at the same time in the store are selected such that a space is provided between them, in other words, such that at least another display shelf is present between them. This structure prevents a large number of consumers from crowding in one place and disperses customers. In this way, shoppers can smoothly move.

In the above example, the sales promotion function is operated in distant areas on the same floor 61. However, the sales promotion function may be operated on different floors.

When a plurality of products whose prices may be changed are present in the store, the price change module 154 is configured to determine price changes by selecting a first product of a first shelf of a first aisle of the store and a second product of a second shelf of a second aisle different from the first aisle. Thus, at least the price change module 154 also manages the display position information of products in the store.

This specification explains that the dynamic pricing management system divides products into a group of KVIs and a group of non-KVIs and differentiates the percentage of change of price of each product of one of the groups from that of the other group.

The present dynamic pricing management system can move a KVI to a group of non-KVIs depending on a condition or move a non-KVI to a group of KVIs depending on a condition.

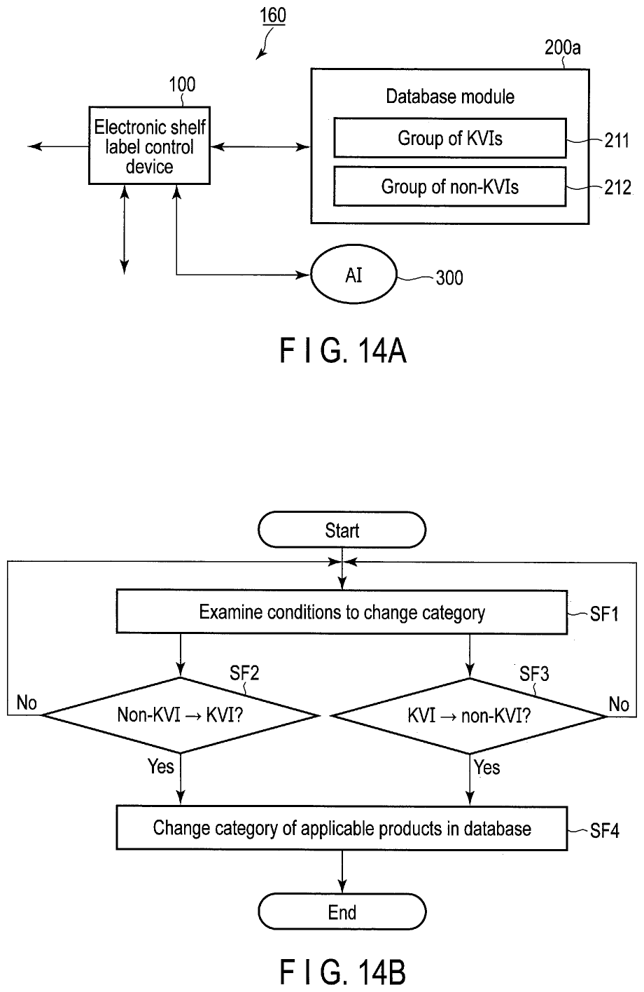

As shown in FIG. 14A, database module 200a manages a group of KVIs 211 and a group of non-KVIs 212. The AI module 300 is configured to provide various types of information. For example, the information includes the following:

the information of the season, seasonal products and non-seasonal products,

the information of seasonal events such as the seven, five and three years children's festival, Children's Day, the equinoctial week, Christmas Day and a night with a full moon,

the information of temperature, and related information such as cold or hot,

the information of weather, and alerting information such as a change in weather or rainstorm,

the information of time periods such as early morning, before lunch, before dinner and return-home time,

the information of area such as a local shopping street, residential street, suburb, business district and the event information of a tourist spot,

the information of customer segments such as elderly people, adults with children and single persons for the current visitors,

the information of a weekend, national holiday and the day before a holiday,

trendy information obtained from fashion, social networking services, etc., and

the information of prices of other stores.

The present dynamic pricing management system can use correlative data of the above various types of information and the sales situation of products.

For example, in the daytime, milks sell well if the price is reduced. However, in the evening, milks sell well even if they are not cheap.

Canned beers sell well on hot days even if the price is not reduced from the set retail price. On cold days, the materials of hot pot dishes sell well even if the prices are not reduced from the set retail prices. When an event is held near the store, the range of discount of snack foods and drinks may be adjusted so as to be less since they sell well.

Based on the above past empirical data, the present management system can move a KVI (for example, milk) in the daytime to a group of non-KVIs in the evening. Cabbage is normally a KVI whose price should be reduced. However, if the information of bad harvests in all areas is obtained, cabbage can be moved to a group of non-KVIs such that the price is not reduced even at the time of reducing the price. If a product of the self-store is cheaper than the same product of another store based on the product information of other stores, the product may be removed from the target of price reduction.

The above matters can be determined by, for example, a method of following the determination information of the AI module 300 which analyzes various types of data and makes a sales prediction (in other words, a prediction on sales, indicating a graph of a sales trend for future several hours). Alternatively, the above matters can be determined by the store on their own accord in consideration of the determination information of the AI module 300. The various types of data are one of or a combination of, for example, weather, temperature, an event near the store, the number of visitors, the analysis data of visitors, the product prices of other stores, import information, manufacturing information, etc., as information different from the products sold in the store and obtained from outside.

FIG. 14B shows an operation flow at the time of the category transfer (classification change) process of a KVI and a non-KVI. For example, the conditions to change the category are regularly examined during a day (SF1). After the conditions are examined based on the information in the AI, whether each product related to the examination should be changed from the category of non-KVIs to the category of KVIs (SF2) or changed from the category of KVIs to the category of non-KVIs (SF3) is determined. The category of each product is changed in database module 200. As a matter of course, the category of some products may not be changed depending on the conditions.

As the above intelligence function is provided, the present dynamic pricing management system can largely contribute to the sales of the store.

Since the present management system uses electronic shelf labels, the management system can collect the movement of people by sensing operation, and when a large number of people stop to look at the price of a product and leave the place, the management system can reduce the price of the product (for example, adaptively carry out special offers available for a limited time of a day). Moreover, the management system can, when a person stops in front of a product, display the explanation and price of the product on the monitor.

The above management based on the situation of people may use human monitoring information from a monitoring camera or may be manually activated.

As described above, the present system can dynamically and immediately change and modify the sales strategy. The system may comprise a processing module which moves a product included in the first product group to the second product group based on a condition set in advance. The process may be immediately performed at any time in a manner similar to that of the change in the prices of products.

When a cash register device is provided and reads the barcode of a product whose price should be changed, the cash register device is configured to apply, to the price of the product, the lowest price applied by the price change module. This function may be on and off by switching an operation mode. A message for offering a further discount or a coupon may be output on the guide screen of the cash register device or by sound depending on the total amount of purchase of products. As change data, the price change module is configured to output data related to the number of remaining pieces to sell to the data output module together with the changed price of each product as explained in FIG. 12 in cooperation with the AI module. This structure is effective in promoting sales. When a plurality of products whose prices may be changed are present in the store, the price change module is configured to determine price changes by selecting the first product of the first shelf of the first aisle of the store and the second product of the second shelf of the second aisle different from the first aisle as explained in FIG. 13 in cooperation with the AI module. The first management module and the second management module are configured to carry out management by switching the category of some products based on the result of analysis of data including one of or a combination of weather, temperature, an event near the store, the number of visitors, the analysis data of visitors, the product prices of other stores, import information, manufacturing information, etc., as information different from the products sold in the store and obtained from outside as explained in FIG. 14B in cooperation with the AI module. Further, as explained in FIG. 9B, data can be supplied to a small electronic shelf label and a large shelf label whose display area is larger than that of the small electronic shelf label. Data related to a list of products around the large shelf label can be output to the large shelf label. Thus, the display and array of products can be customer-friendly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Even if a plurality of embodiments are combined with each other and adopted, the combinations are within the scope of the present invention.

What is claimed is:

1. A dynamic pricing management system comprising:
an operation device which calculates and determines product information of each product to be displayed;
a plurality of electronic shelf labels each comprising a display module which allows the product information to be displayed and rewritten;
a communication device which allows exchange of the product information between the electronic shelf labels and the operation device;
a database unit in which basic information of each product is stored;
a management device which manages sales or inventory information of each product; and
an other-than-product data collection device which collects and accumulates fluctuation data other than products with time, wherein
the operation device determines current product information and issues an instruction to rewrite the product information of the display module based on the basic information, the sales or inventory information and past and current fluctuation data.

2. The dynamic pricing management system of claim 1, wherein
the product information is a price of each product.

3. The dynamic pricing management system of claim 1, wherein
when the operation device determines the product information, the operation device categorizes the products displayed in a store into products with high awareness and products with low awareness based on the basic information, sales performance information and fluctuation data, takes in a parameter of the categories and determines the product information.

4. The dynamic pricing management system of claim 1, wherein
the operation device sets the range of fluctuation for a standard price of a product with high awareness so as to be less than the range of fluctuation for a standard price of a product with low awareness.

5. The dynamic pricing management system of claim 1, wherein
the fluctuation data is weather information of a place of a store.

6. The dynamic pricing management system of claim 1, wherein
the fluctuation data is a time.

7. The dynamic pricing management system of claim 1, wherein
the fluctuation data is data related to an event held near a store.

8. The dynamic pricing management system of claim 1, wherein
the fluctuation data is a result of analysis of data including one of or a combination of the number of visitors, analysis data of visitors, product prices of other stores, import information, manufacturing information.

9. A dynamic pricing management system comprising:
a plurality of electronic shelf labels attached to a plurality of types of products on display, respectively, and each of the electronic shelf labels comprising a display module for displaying product information of a corresponding product;
a database unit in which basic information of each product is stored;
an other-than-product data collection device which collects and accumulates fluctuation data other than products with time;
an operation device which calculates and determines product information based on the basic information and the fluctuation data; and
a transmission device which transmits the product information determined by the operation device to the electronic shelf labels, wherein
the basic information includes at least category information indicating whether each product is categorized into a first product group or a second product group with price awareness lower than the first product group, and
when the operation device determines the product information, the operation device sets a frequency of price changes and/or a range of fluctuation of the first product group so as to be less than a frequency of price changes and/or a range of fluctuation of the second product group.

10. The dynamic pricing management system of claim 9, wherein
the product information is a price of each product.

11. The dynamic pricing management system of claim 9, wherein
when the operation device determines the product information, the operation device categorizes the products displayed in a store into products with high awareness and products with low awareness based on the basic information, sales performance information and fluctuation data, takes in a parameter of the categories and determines the product information.

12. The dynamic pricing management system of claim 9, wherein
the operation device sets the range of fluctuation for a standard price of a product with high awareness so as to be less than the range of fluctuation for a standard price of a product with low awareness.

13. The dynamic pricing management system of claim 9, wherein
the fluctuation data is weather information of a place of a store.

14. The dynamic pricing management system of claim 9, wherein
the fluctuation data is a time.

15. The dynamic pricing management system of claim 9, wherein
the fluctuation data is data related to an event held near a store.

16. The dynamic pricing management system of claim 9, wherein
the fluctuation data is a result of analysis of data including one of or a combination of the number of visitors, analysis data of visitors, product prices of other stores, import information, manufacturing information.
